(19) United States
(12) Patent Application Publication
(10) Pub. No.: US 2018/0117709 A1
(43) Pub. Date: May 3, 2018

(54) METHOD AND DEVICE FOR LOCALLY DEFINED MACHINING ON THE SURFACES OF WORKPIECES USING LASER LIGHT

(71) Applicant: FRAUNHOFER-GESELLSCHAFT ZUR FOERDERUNG DER ANGEWANDTEN FORSCHUNG E.V., Muenchen (DE)

(72) Inventors: Andreas WETZIG, Dresden (DE); Udo KLOTZBACH, Dresden (DE); Michael PANZNER, Dresden (DE); Andreas GEHNER, Dresden (DE); Peter DUERR, Dresden (DE); Alexander MAI, Dresden (DE)

(73) Assignee: FRAUNHOFER-GESELLSCHAFT ZUR FOERDERUNG DER ANGEWANDTEN FORSCHUNG E.V., Muenchen (DE)

(21) Appl. No.: 15/570,050

(22) PCT Filed: Apr. 27, 2016
(86) PCT No.: PCT/EP2016/059360

§ 371 Date: Oct. 27, 2017

(30) Foreign Application Priority Data
Apr. 28, 2015 (DE) 10 2015 106 548.7
Sep. 14, 2015 (DE) 10 2015 217 523.5

(51) Int. Cl. B23K 26/06; B23K 26/00; B23K 26/067; B23K 26/082; B23K 26/361

(52) U.S. Cl. CPC B23K 26/0643; B23K 26/0006; B23K 26/361; B23K 26/0673; B23K 26/082; B23K 26/0084

(57) ABSTRACT

The invention relates to a method and a device for locally defined machining on surfaces of workpieces. A laser beam (1) emitted by a laser radiation source (2) is aimed onto the reflecting surfaces of a plurality of adjacently arranged micromirrors that may be controlled individually with an electronic control and that are pivotable about at least one axis. Sub-beams (4) reflected by the reflecting surfaces of the micromirrors pivoted in a defined manner are incident and focused on the surface of a workpiece, which surface is arranged in the focal plane (6) of the focusing optics unit (5), at different adjustable positions, so that simultaneously a locally defined change in the workpiece material and/or a locally defined material removal with prespecifiable geometry is attained in a region of the workpiece near its surface. If a plurality of sub-beams (4) are incident together on the same position in the focal plane (6) of the focusing optics unit (5), these sub-beams (4) overlay one another in an incoherent manner.

The invention relates to a method and device for locally defined machining on the surfaces of workpieces using laser light. The method is especially suitable for creating markings, structuring, microstructural changes, or removing material from surfaces of workpieces or similar structures. In doing so, patterns may be created on the surface in a locally defined manner due to a material modification, e.g. a color change or a change in the microstructure or lattice structure of the material from which a workpiece or a coating embodied on the surface is made. Likewise it is possible to create patterns and structures using a locally defined removal of material, as well.

In laser material machining, in principle a distinction may be made between direct writing (point-form machining) and surface machining of a component.

The direct writing is generally accomplished by means of a focused laser beam and using the appropriate relative movement between laser beam focal point and workpiece. But this requires a greater amount of time, since the entire contour must be traveled with the focal point of a laser beam at least once.

During processing by means of direct writing, in the most simple case the laser beam is focused such that power densities that are high enough to permit a corresponding material heating or material removal are attained in the focal point on the workpiece surface to be machined. In many applications, however, this is not adequate because writing is supposed occur on the workpiece with an intensity distribution of the beam that goes beyond the Gaussian shape. Alternative intensity distributions in the writing laser beam may be attained by using diffractive-optical units (DOEs).

Currently adaptive, rapidly controllable beam shaping methods exist for only a few applications of the direct writing method. For instance, to influence the energy input via the cross-section of the focal point when the contour to be created is being traveled, instant return mirrors (scanners) that overlay a rapid pivot movement (frequently called a wobble) perpendicular to the actual writing movement are placed in the beam path. The intentional triggering of this laser beam deflection movement permits rapidly adapted control of the energy input profile.

In addition to the sequential machining of a workpiece with the focused laser beam, the machining may also occur two-dimensionally, i.e. in parallel. For this, primarily two methods for forming the desired two-dimensional pattern may be distinguished. These are: a) mask projection methods and b) a pattern generation by means of a diffractive optical unit (DOE).

In mask projection a), the imaging mask is reproduced in the actual machining plane of the workpiece. In pattern creation by means of DOE, b) deflection occurs on the phase-shifting structures of the DOE and decomposition occurs into the specific spatial frequencies.

Changing the pattern or the intensity distribution on the workpiece to be machined may only be accomplished, both with the use of DOEs and in mask projection, by exchanging the specific imaging element. However, many processes require rapid and flexible exchange of the intensity profiles or rapid contour changes. Classic examples of this are marking applications in which a continuously rapid exchange of a structural image to be created or of a defined machining geometry is necessary.

In the mask projection method a), the imaging mask is projected in the actual machining plane. A reduction in the imaging structures attained by projection permits both the creation of smaller structures and the attainment of higher power density in the machining plane than on the actual mask. The use of rigid masks made of glass, quartz, or metal for applications, e.g. in photolithography or laser material machining, is still quite common. The drawback of such rigid masks is the lack of flexibility and the need to exchange the mask to attain changes in the projected pattern.

In addition to the rigid masks, programmable masks for two-dimensional pattern creation have been used for some time in many fields in the so-called light valve principle. Examples of this include image projection in movie theater projectors, DUV microlithography, digital plate exposure, and 3D printing by means of DLP®. The light valve principle used in these includes the fact that the electromagnetic radiation incident on the imaging element is modulated in its intensity by masking of pixels. A drawback of this principle is the loss of the part of the incident electromagnetic radiation that is masked for producing contrast. This loss in the masked radiation represents a significant disadvantage, in particular in applications that require high radiant power and rapid material throughput. In this case it is not possible to use all of the available radiant energy.

In two-dimensional pattern creation by means of DOE b), the imaging element adds pure phase modulation to the incident wavefront of the electromagnetic radiation. Rigid DOEs in glass, quarts, or plastics are used, as well as programmable units. Such programmable DOEs are based on very different structures, such as e.g. on the principle of drop mirror templates or liquid crystal units. In the case of liquid crystal units, there is a difference between so-called reflective liquid crystal on silicon (LCOS) and transmissive liquid crystal (LC) microdisplays. Applications that have already been realized for the programmable DOEs are, inter alia, in the fields of ophthalmology, adaptive wavefront correction in dynamic media, and laser material machining. The use of coherent radiation is absolutely necessary for applying this principle of pattern creation. It is also a drawback when using programmable DOEs that in this case very many very small pixels are required, and they are correspondingly difficult to produce. In addition, huge quantities of data are required to control them, and correspondingly high complexity in address electronics is involved.

It is therefore the object of the invention to provide options for laser machining on surfaces of workpieces, with which options different patterns may be created rapidly and with flexibility and nearly complete utilization of the radiation energy is possible.

According to the invention, this object is attained with a method that has the features of claim 1. Claim 14 relates to a device for executing the method. Advantageous embodiments and refinements of the invention may be created with features identified in subordinate claims.

In the inventive method, a laser beam emitted by a laser radiation source is directed onto the reflecting surfaces of a plurality of adjacently arranged micromirrors that may be pivoted about at least one axis and that may be controlled with an electronic control.

Proceeding from the reflecting surfaces of each micromirror pivoted in a defined manner, reflected sub-beams are focused on a workpiece surface arranged in the focal plane of a focusing optics unit and are incident on different, adjustable positions.

Because of this, a locally defined change in the workpiece material and/or a locally defined removal of material, with prespecifiable geometry, is/are simultaneously attained in a region of the workpiece close to its surface.

If a plurality of sub-beams together are incident on the same position in the focal plane of the focusing optics unit, these sub-beams overlay one another in an incoherent manner.

A focusing optics unit should be arranged, relative to the surface of the workpiece, and embodied such that the focused sub-beams are incident on the workpiece surface arranged in the focal plane.

To ensure that the surface of the workpiece and the focal plane are arranged in the same plane, a translational movement of the workpiece may be executed to appropriately adjust the distance between the surface of the workpiece and the focusing optics unit used. By itself, or in addition, the focusing optics unit, possibly together with the micromirrors and the laser radiation source, may be moved appropriately translationally.

The quantity of energy input into the workpiece at the specific points may be influenced by the number of sub-beams incident on the specific points.

A focusing optics unit used should preferably be arranged in the beam path of the laser radiation downstream of the spatial light modulator so that the individual sub-beams are focused. It is also possible, however, to place the focusing optics unit in the beam path upstream of the SLM. The workpiece surface and the focal plane of the focusing optics unit coincide in both cases, however.

By adjusting the micromirror pivot angle it is possible to freely position the sub-beams in the focal plane of the focusing optics unit and thus on the surface of the workpiece in question. An individual image point within the entirety of the pattern to be created may be generated by placing as desired an individual sub-beam or incoherent overlaying of two or more sub-beams. By energizing appropriately, the pivoting of one or a plurality of micromirrors may be changed very rapidly or even retained for a specific time period. Thus new patterns may be realized very rapidly or retained selectively so that a high degree of flexibility may be attained. It is possible to freely control the intensity distribution of a laser beam profile generated by means of SLM for creating patterns.

Advantageously, a spatial light modulator (SLM) in which the micromirrors are arranged in a row and column arrangement may be used.

Laser machining of the surface, both over a large surface area and at different positions of the workpiece, may be executed using a relative movement between SLM and the workpiece.

An arrangement of micromirrors that may be used in the invention may be identified as a spatial light modulator or as a micromirror SLM, a sub-group of so-called MOEMS (micro-opto-electro-mechanical system). The individual micromirrors are attached to a frame using torsion and/or spiral springs and may be pivoted by means of electrodes that should preferably be arranged below the individual micromirrors. By intentionally energizing the electrodes, the individual mirrors may be pivoted selectively about one or two axes that are arranged parallel to the reflecting surface. In this way some of the laser light that is incident on the SLM may be reflected at a specific angle as a sub-beam by the corresponding reflecting surface pivoted at an angle. The sub-beams reflected by different micromirrors may thus be directed at different angles towards the workpiece surface to be machined.

In addition to the pivoting, an overlaid translational excursion of the micromirrors with their reflecting surfaces is also possible. This may be attained by simultaneously energizing a plurality of electrodes with the same electrical voltage. Such a reduction in individual or multiple micromirrors does not have any significant effect on the method described here, however, since the sub-beams are incoherent to one another. Essentially it is only possible to effect a change in the phasing with this.

The sub-beams reflected by the reflecting surfaces of the micromirrors may advantageously be directed onto a surface of the workpiece, in focused form, through a plane field or F-theta lens in a simple or telecentric design. The goal is to produce the most diffraction-limited image points possible. However, other focusing units, for example microscope lenses or individual lenses designed as biconvex lenses, plane convex lenses, lenses of best shape or aspheres, may also be used.

In the invention, it is particularly advantageous when the laser beam is incident on the reflecting surfaces of all micromirrors and the sub-beams that are reflected by all of the micromirrors are incident on the surface of the workpiece simultaneously with the locally defined laser machining.

The micromirrors should to the greatest extent possible be pivoted such that the sub-beams do not interfere on the workpiece surface to be machined.

Any lasers for material machining, such as e.g., an ultra-short pulse laser, a pulsed Nd:YAG laser, pulsed fiber laser, pulsed CO2 laser, CO2 TEA laser, or excimer laser may be used for the laser radiation source.

The laser beam should be incident on the reflecting surfaces of the micromirrors as parallel as possible with a slight divergence. At least one suitable beam-shaping unit may be used for this.

By using spatial light modulators, the wavefront of focused laser radiation may be changed adaptively such that secondarily occurring wavefront changes may be corrected, as a consequence of the influence on the optics unit, by the laser beam itself, which changes lead in particular to focal length changes.

The invention thus in principle relates to the use of a micromirror-based spatial light modulator (SLM) as a programmable imaging element for pattern creation, beam formation, and beam positioning for applications in the field of laser material machining.

In contrast to earlier approaches, the present invention assumes that markings or patterns to be created are embodied on the surface of a workpiece, in its focal plane and with geometry that is prespecifiable by the electronic control unit, immediately after the laser radiation passes through a focusing optical unit. To this end, using intentional pivoting of all of the micromirrors in the arrangement on which a laser beam is incident, bundles of sub-beams that are incident on a focusing optics unit downstream of the SLM are generated. When there is corresponding incoherent light and idealized optical beam paths, corresponding to the geometrical optics, the position of the image points in the focal plane of the focusing optics unit depends only on the tangent of the angle at which the sub-beams are reflected onto the reflecting surfaces of the micromirrors, multiplied by the focal length of the focusing optics unit. With special lenses, so-called F-theta lenses, it is even possible to attain a linear dependence on the angle. In this way a free pixel graphic can be created in the focal plane. The intensity and power density in an image point, that is, of a sub-beam at a specific position, is a function of the number of correspondingly identically displaced micromirrors.

In the focal plane, desired laser beam intensity distribution may be attained with which special types of removal, influence on material, or marking may occur. A locally differentiated energy input into the workpiece surface is possible that leads, for example, to a locally defined material removal or modification of the material. It is therefore possible to create a cut with a rectangular profile, for instance, with a box-shaped intensity profile using relative movement between laser beam and workpiece.

The so-called beam-steering technology with spatial light modulator permits a rapid and flexible option for the marking or pattern creation, beam shaping and beam positioning within a defined image field. One possible use is in nearly all fields of laser material machining, both for two-dimensional structuring and with direct writing with a focused individual beam.

The SLM may function here as a programmable imaging element. No change in the imaging element is needed. Thus changes to markings or patterns, beam profile or position may be realized very rapidly and flexibly by controlling the pivot angle of one or a plurality of micromirrors.

Using a new imaging principle prevents energy losses. There is no partial masking of the electromagnetic radiation of the incident laser light for forming the desired structures, as there is in the light valve principle used until now. All of the power of the laser beam used that is reflected by the SLM, that is, the micromirrors, may be used for machining the workpiece. The pattern may be created directly in the focal plane of the focusing optics unit. This may reduce the number of necessary optical units that must be arranged in the beam path of the laser beam.

The beam-steering technology with SLM permits the modulation of the intensity in the machining plane. This results in potential uses in nearly all fields of laser material machining. Using the locally defined energy input, it is possible to attain a marking with the prespecified geometry using phase or microstructural transformation, as well as using color changing of the material being machined. Likewise, direct structuring is possible using removal of workpiece material. As much of the material removal as possible should be attained by ablation. Moreover, flexible exposure processes, e.g. by photo resists, may also be realized.

The flexible and rapid modulation of the intensity may be used very advantageously for two-dimensional structuring. The SLM functions a programmable imaging element and has the potential to replace rigid masks and DOEs of methods that have been well-established in the past. Applications of interest are, e.g. tasks of microstructuring or writing that require a rapid pattern change. Labeling of cable sheathing or packaging with sequential numbers, time, or date is possible. In addition to two-dimensional structuring, removal of volume is also associated with novel possibilities. 2D and 3D structures (without undercuts, however) may be realized by means of adapting steel profile or machining pattern in different planes.

In the field of direct writing, the technology makes possible free formation and positioning of the beam profile and thus control of the added temperature profile.

The invention shall be described in the following using an example.

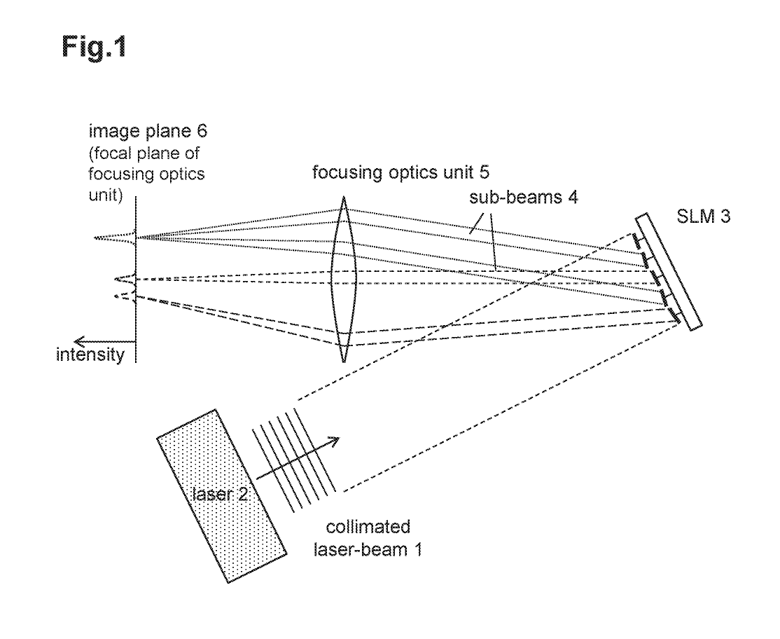

FIG. 1 is a schematic illustration of an example of an arrangement that may be used when executing the inventive method. In the variant illustrated here, the focusing optics unit 5 is arranged between the SLM 3 and the image plane (focal plane of the focusing optics unit) 6.

A collimated laser beam 1 is directed onto a spatial light modulator (SIM) 3 by a laser radiation source 2. The SLM 3 represents a 2-dimensional arrangement of many micromirrors. In this example, the micromirrors are each pivotable, individually and independently, about two axes that are arranged perpendicular to one another.

The sub-beams 4 (of which only a few are depicted for the sake of simplicity) reflected by the individual reflecting surfaces of all of the micromirrors are incident on the focusing optics unit 5, which in this example is indicated by a simple focusing lens. The sub-beams 4 are directed onto the surface of a workpiece, indicated here with the focal plane of the focusing optics unit 6. The surface of the workpiece and the focal plane of the focusing optics unit 6 are arranged in the same plane.

Each individual micromirror is pivoted such that its sub-beam 4 is incident on a prespecified position. Sub-beams 4 that are reflected by the SLM 3 at the same angle and are incident on a common point in the image plane should overlay one another in an incoherent manner. All sub-beams 4 are incident, simultaneously locally defined, on the specific surface, so that a prespecified image of a specific geometry that is prespecifiable using an electronic control (not shown) is attained.

The laser radiation source 2 may be operated pulsed and, depending on the desired machining and taking into account the material of a workpiece or a coating embodied thereon, at a suitable power and wavelength.

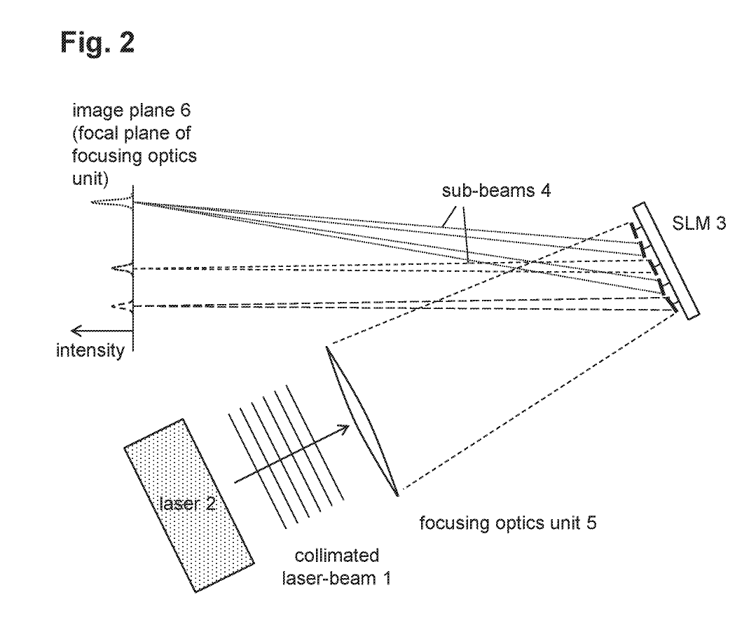

FIG. 2 is a schematic illustration of an example of an arrangement that may be used when executing the inventive method. In the variant illustrated here, the focusing optics unit 5 is arranged between the laser radiation source 2 and the SLM 3.

1. A method for locally defined machining on the surfaces of workpieces using laser light, in which method a laser beam (1) emitted by a laser radiation source (2) is directed onto the reflecting surfaces of a plurality of adjacently arranged micromirrors that may be pivoted about at least one axis and that may be controlled with an electronic control, and
from the reflecting surfaces of each micromirror pivoted in a defined manner, reflected sub-beams (4) are focused on a workpiece surface arranged in the focal plane (6) of a focusing optics unit (5) and are incident on different, adjustable positions, such that
a locally defined change in the workpiece material and/or a locally defined removal of material, with predeterminable geometry, is simultaneously attained in a region of the workpiece close to its surface;
wherein, if a plurality of sub-beams (4) together are incident on the same position in the focal plane (6) of the focusing optics unit (5), these sub-beams (4) overlay one another in an incoherent manner.

2. The method according to claim 1, characterized in that a spatial light modulator (SLM) (3) is used in which the micromirrors are arranged in a rows and columns arrangement.

3. The method according to claim 1, characterized in that the micromirrors and the workpiece are moved relative to one another.

4. The method according to claim 1, characterized in that the laser beam (1) is incident on the reflecting surfaces of all of the micromirrors and the sub-beams (4) that are reflected by all of the micromirrors are incident on the surface of the workpiece simultaneously with the locally defined laser machining.

5. The method according to claim 1, characterized in that the micromirrors are pivoted such that the sub-beams (4) that are strike one another in the focal plane (6) of the focusing optics unit (5) do not interfere with one another, but instead overlay one another in an incoherent manner.

6. The method according to claim 1, characterized in that the focusing optics unit (5) is arranged between the spatial light modulator (3) and the surface of the workpiece.

7. The method according to claim 1, characterized in that the focusing optics unit (5) is arranged between the laser radiation source (2) and the spatial light modulator (3).

8. The method according to claim 1, characterized in that individual lenses embodied as biconvex lenses, plan convex lenses, lenses of best shape or aspheres or microscope lenses, plan field lenses, or F-theta lenses, in a simple or telecentric design, are used as the focusing optics unit (5).

9. The method according to claim 1, characterized in that an ultra-short pulse laser, pulsed Nd:YAG laser, pulsed fiber laser, pulsed CO2 laser, CO2-TEA laser, or excimer laser is used for the laser radiation source (2).

10. The method according to claim 1, characterized in that at least one marking is created as a pattern with the locally defined laser machining.

11. The method according to claim 1, characterized in that, by using spatial light modulators (3), the wavefront of focused laser radiation is changed adaptively such that secondarily occurring wavefront changes are corrected, as a consequence of the influence on the optics unit, by the laser beam itself, which changes lead in particular to focal length changes.

12. A device for executing the method according claim 1, characterized in that a laser beam (1) emitted by a laser radiation source (1) is directed onto a plurality of adjacently arranged micromirrors that are pivotable about at least one axis, and
sub-beams (4) reflected by micromirrors are incident focused on different positions of the surface; wherein
a focusing optics unit (5) is arranged and embodied in the beam path such that the focused sub-beams (4) are incident on the workpiece surface arranged in the focal plane (6) and if a plurality of sub-beams (4) are incident on the same position together, these sub-beams (4) overlay one another in an incoherent manner.
